(19) United States
(12) Patent Application Publication
(10) Pub. No.: US 2024/0096020 A1
(43) Pub. Date: Mar. 21, 2024

(54) APPARATUS AND METHOD FOR GENERATING MOVING VIEWPOINT MOTION PICTURE

(71) Applicant: ELECTRONICS AND TELECOMMUNICATIONS RESEARCH INSTITUTE, Daejeon (KR)

(72) Inventors: Jung Jae YU, Daejeon (KR); Jae Hwan KIM, Daejeon (KR); Ju Won LEE, Daejeon (KR); Won Young YOO, Daejeon (KR)

(73) Assignee: ELECTRONICS AND TELECOMMUNICATIONS RESEARCH INSTITUTE, Daejeon (KR)

(21) Appl. No.: 18/468,162

(22) Filed: Sep. 15, 2023

(30) Foreign Application Priority Data
Sep. 16, 2022 (KR) 10-2022-0117383

(51) Int. Cl. G06T 17/20; G06T 5/00; G06T 7/194; G06T 7/20; G06T 7/40

(52) U.S. Cl. CPC G06T 17/20; G06T 5/005; G06T 7/194; G06T 7/20; G06T 7/40

(57) ABSTRACT

A method of generating a moving viewpoint motion picture, which is performed by a processor that executes at least one instruction stored in a memory, may comprise: obtaining an input image; generating a trimap from the input image; generating a depth map using the input image; generating a foreground mesh/texture map model based on a foreground alpha map obtained based on the trimap and foreground depth information obtained based on the trimap and the depth map; and generating a moving viewpoint motion picture based on the foreground mesh/texture map model.

### CROSS-REFERENCE TO RELATED APPLICATIONS

This application claims priority to Korean Patent Application No. 10-2022-0117383, filed on Sep. 16, 2022, with the Korean Intellectual Property Office (KIPO), the entire contents of which are hereby incorporated by reference.

### BACKGROUND

### 1. Technical Field

Example embodiments of the present disclosure relate to an apparatus and method for generating a moving viewpoint motion picture, and particularly to, an apparatus and method for generating an improved moving viewpoint motion picture to effectively represent details of an object and a three-dimensional (3D) effect.

### 2. Related Art

The contents described herein are intended to merely provide background information of embodiments set forth herein and should not be understood as constituting the related art.

Recently, with an increase in the amount of video content, techniques for editing and synthesizing images have been provided. For example, Apple's “IMOVIE,” Google's “PHOTO,” and NAVER's “Blog APP” include a function of editing customized videos and easily uploading videos to a platform.

Apple's IMOVIE includes a function of providing and recommending storyboards to edit genre forms such as horror movies and dramas. Google's PHOTO provides a timeline function of collecting captured photos and videos from a user's smart phone and visually arranging the photos and the videos using an album function. NAVER's Blog APP provides functions of shooting videos, separating audio, editing subtitles, and extracting still images.

In addition, methods of producing or editing videos using photos are being studied and developed, and various types of services providing an add-on to an existing application program or providing an add-on through a separate application program are being provided.

Recently, it has been reported that the performance of video synthesis and production has been improved as the related art has been combined with artificial neural network technology represented by deep learning.

However, even when such an existing method is used, a technique for generating a three-dimensional (3D) video when an input image is a two-dimensional (2D) image is not yet highly complete, and there are many aspects to be improved.

### SUMMARY

In the related art, when a moving viewpoint motion picture is generated using an input image, it is very difficult to perform a technique for generating a three-dimensional (3D) model and express a sense of separation from the background for a detailed area at the level of hair. This is because it is very difficult to generate a 3D mesh model for detailed areas such as hair and body hair.

To address the problems of the related art, the present disclosure is directed to providing a method of differentiating the foreground and background in a detailed region such as hair and expressing a 3D effect, when a depth map is estimated from an input image, a 2.5D model is generated, and a moving viewpoint motion picture that is substantially the same as that captured while moving a camera forward is generated.

The present disclosure is directed to providing an apparatus and method for effectively combining a process of generating a 2.5D model having a 3D effect with a process of expressing details, such as hair, to generate a moving viewpoint motion picture from an input image and effectively expressing both a 3D effect and details.

The present disclosure is directed to a technique for effectively expressing a 3D effect and details while reducing the amount of calculation and a memory usage in effectively combining a process of generating a 2.5D model having a 3D effect with a process of expressing details, such as hair, to generate a moving viewpoint motion picture from an input image.

According to a first exemplary embodiment of the present disclosure, an apparatus for generating a moving viewpoint motion picture may comprise: a memory; and a processor configured to execute at least one instruction stored in the memory, wherein the processor may be configured to, by executing the at least one instruction: obtain an input image; generate a trimap from the input image; generate a foreground mesh/texture map model based on a foreground alpha map obtained based on the trimap and foreground depth information obtained based on the trimap; and generate a moving viewpoint motion picture based on the foreground mesh/texture map model.

The processor may be further configured to: generate the trimap to include an extended foreground area including a first region and a second region, the first region being an invariant foreground region of the input image and the second region being a boundary region between a foreground and a background of the input image; and generate the foreground mesh/texture map model including a three-dimensional (3D) mesh model for the extended foreground area.

The processor may be further configured to apply the foreground alpha map to a texture map for the second region.

The processor may be further configured to generate the foreground mesh/texture map model including information about a relationship between texture data and a 3D mesh for an extended foreground area, wherein the texture data is generated based on the foreground alpha map, and the extended foreground area includes a first region that is an invariant foreground region of the input image and a second region that is a boundary region between a foreground and a background of the input image.

The processor may be further configured to: generate a depth map for the input image; and generate the foreground depth information using the trimap and the depth map, wherein the trimap includes an extended foreground area including a first region that is an invariant foreground region of the input image and a second region that is a boundary region between a foreground and a background of the input image.

The processor may be further configured to: perform hole painting on a background image including a third region which is an invariant background region of the input image; and generate a background mesh/texture map model using a result of hole painting on the background image.

The processor may be further configured to: generate a depth map for the input image; generate initialized background depth information by applying the depth map to the third region which is the invariant background region of the input image; perform hole painting on the background depth information; and generate the background mesh/texture map model using a result of hole painting on the background depth information and the result of hole painting on the background image.

The processor may be further configured to: generate a camera trajectory by assuming a movement of a virtual camera; and generate the moving viewpoint motion picture using the foreground mesh/texture map model and a background mesh/texture map model at a moving viewpoint generated based on the camera trajectory.

The processor may be further configured to generate the trimap based on a user input for the input image.

The processor may be further configured to automatically generate the trimap based on the input image.

According to a second exemplary embodiment of the present disclosure, a method of generating a moving viewpoint motion picture, which is performed by a processor that executes at least one instruction stored in a memory, may comprise: obtaining an input image; generating a trimap from the input image; generating a depth map using the input image; generating a foreground mesh/texture map model based on a foreground alpha map obtained based on the trimap and foreground depth information obtained based on the trimap and the depth map; and generating a moving viewpoint motion picture based on the foreground mesh/texture map model.

The generating of the trimap may comprise: generating the trimap to include an extended foreground area including a first region and a second region, the first region being an invariant foreground region of the input image and the second region being a boundary region between a foreground and a background of the input image, and the generating of the foreground mesh/texture map model may comprise: generating the foreground mesh/texture map model including a three-dimensional (3D) mesh model for the extended foreground area.

The generating of the foreground mesh/texture map model may comprise: generating the foreground mesh/texture map model by applying the foreground alpha map to a three-dimensional (3D) mesh model for the second region.

The generating of the foreground mesh/texture map model may comprise: generating the foreground mesh/texture map model including information about a relationship between texture data and a 3D mesh for an extended foreground area, wherein the texture data is generated based on the foreground alpha map, and the extended foreground area includes a first region that is an invariant foreground region of the input image and a second region that is a boundary region between a foreground and a background of the input image.

The generating of the foreground mesh/texture map model may comprise: generating the foreground depth information using the trimap and the depth map, wherein the trimap includes an extended foreground area including a first region that is an invariant foreground region of the input image and a second region that is a boundary region between a foreground and a background of the input image.

The method may further comprise: performing hole painting on a background image including a third region which is an invariant background region of the input image; and generating a background mesh/texture map model using a result of hole painting on the background image.

The method may further comprise: generating a depth map for the input image; generating initialized background depth information by applying the depth map to the third region which is the invariant background region of the input image; and performing hole painting on the background depth information, and wherein the generating of the background mesh/texture map model comprises generating the background mesh/texture map model using a result of hole painting on the background depth information.

The method may further comprise: generating a camera trajectory by assuming a movement of a virtual camera, and the generating of the moving viewpoint motion picture may comprise: generating the moving viewpoint motion picture using the foreground mesh/texture map model and a background mesh/texture map model at a moving viewpoint generated based on the camera trajectory.

The generating of the trimap may comprise: receiving a user input for the input image; and generating the trimap based on the user input.

The generating of the trimap may comprise: analyzing the input image; and automatically generating the trimap based on a result of analyzing the input image.

According to an embodiment of the present disclosure, there is no need to additionally generate a mesh model for detailed regions such as hair and body hair, and a mesh model can be generated for a “foreground area” set by a predetermined method and an “alpha map” for determining transparency can be applied to a texture map, so that a sense of separation from the background and an indirect 3D effect can provided for detailed regions such as hair and body hair.

According to an embodiment of the present disclosure, the foreground and background can be differentiated from each other in a detailed region such as hair and a 3D effect can be expressed, when a depth map is estimated from an input image, a 2.5D model is generated, and a moving viewpoint motion picture that is substantially the same as that captured while moving a camera forward is generated.

According to the present disclosure, a process of generating a 2.5D model having a 3D effect can be effectively combined with a process of expressing details, such as hair, to generate a moving viewpoint motion picture from an input image, and both a 3D effect and details can be effectively expressed.

According to the present disclosure, a 3D effect and details can be effectively expressed while reducing the amount of calculation and a memory usage in effectively combining a process of generating a 2.5D model having a 3D effect with a process of expressing details, such as hair, to generate a moving viewpoint motion picture from an input image.

### BRIEF DESCRIPTION OF DRAWINGS

FIG. 1 is a flowchart of a method of generating a moving viewpoint motion picture according to an embodiment of the present disclosure.

FIG. 2 is a detailed flowchart of some operations included in a method of generating a moving viewpoint motion picture according to an embodiment of the present disclosure.

FIG. 3 is a detailed flowchart of some operations included in a method of generating a moving viewpoint motion picture according to an embodiment of the present disclosure.

FIG. 4 is a conceptual diagram illustrating an intermediate result generated in a process of generating a moving viewpoint motion picture according to an embodiment of the present disclosure.

FIG. 5 is a flowchart of some operations included in a method of generating a moving viewpoint motion picture and an intermediate result according to an embodiment of the present disclosure.

FIG. 6 is a conceptual diagram illustrating an example of a generalized apparatus or computing system for generating a moving viewpoint motion picture, which is capable of performing at least some of the methods of FIGS. 1 to 5.

### DETAILED DESCRIPTION OF THE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

Even technologies known prior to the filing date of the present application may be included as a part of the configuration of the present disclosure as necessary and are described herein within a range that does not obscure the spirit of the present disclosure. However, in the following description of the configuration of the present disclosure, matters of technologies that are known prior to the filing date of the present application and that are obvious to those of ordinary skill in the art are not described in detail when it is determined that they would obscure the present disclosure due to unnecessary detail.

For example, a process of segmenting an input image into a foreground and a background and generating a foreground mask and a background mask, a process of generating an alpha map from the input image by adding, as an alpha channel, information about the probability that each pixel is included in the foreground or the transparency of each pixel, a process of generating a depth map by extracting depth information from a two-dimensional (2D) input image, and the like may be technologies known prior to the filing date of the present application, and at least some of the known technologies may be applied as key technologies necessary to implement the present disclosure.

However, the present disclosure is not intended to claim rights to the known technologies, and the contents of the known technologies may be incorporated as part of the present disclosure without departing from the spirit of the present disclosure.

Hereinafter, embodiments of the present disclosure will be described in more detail with reference to the accompanying drawings. In describing the present disclosure, in order to facilitate an overall understanding thereof, the same components are assigned the same reference numerals in the drawings and are not redundantly described herein.

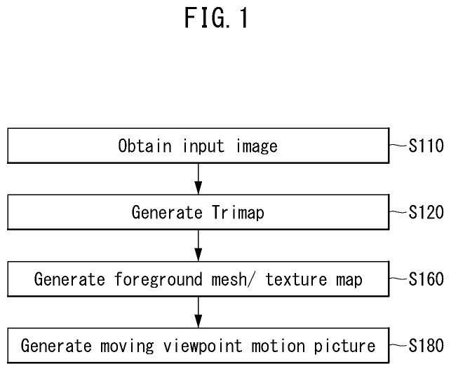

FIG. 1 is a flowchart of a method of generating a moving viewpoint motion picture according to an embodiment of the present disclosure.

In an embodiment of the present disclosure, the method of generating a moving viewpoint motion picture may be performed by a processor that executes at least one instruction stored in a memory.

A method of generating a moving viewpoint motion picture according to an embodiment of the present disclosure includes generating a trimap from an input image (S120), generating a foreground mesh/texture map model based on a foreground alpha map obtained based on the trimap and foreground depth information generated based on the trimap (S160); and generating a moving viewpoint motion picture based on the foreground mesh/texture map model (S180).

The method of generating a moving viewpoint motion picture according to the embodiment of the present disclosure may further include receiving and/or obtaining an input image or receiving an input of the input image (S110). In this case, in the receiving/obtaining of the input image or the receiving the input of the input image (S110), an input image, which is a color image with RGB values, may be input. The receiving/obtaining of the input image or the receiving the input of the input image may be performed through a communication interface 1300 and/or an input user interface 1500 included in a computing system 1000 of FIG. 6. Alternatively, the receiving/obtaining of the input image or the receiving the input of the input image may be performed by retrieving an input image stored in a storage device 1400.

The generating of the trimap (S120) may include generating a trimap with an extended foreground area that includes a first region, which is an invariant foreground region in the input image, and a second region, which is a boundary region between a foreground and a background in the input image.

The generating of the foreground mesh/texture map model (S160) may include generating a foreground mesh/texture map model including a 3D mesh model for the extended foreground area (the first region+the second region).

The generating of the foreground mesh/texture map model (S160) may include generating a foreground mesh/texture map model by applying the foreground alpha map to the 3D mesh model for at least the second region. According to various embodiments of the present disclosure, the 3D mesh model may be implemented for the extended foreground area (the first region+the second region). It may be understood that the foreground alpha map is applied to a texture map for at least the second region.

The generating of the foreground mesh/texture map model (S160) may include generating a foreground mesh/texture map model that includes information about a relation between texture data generated based on the foreground alpha map and the 3D mesh model for the extended foreground area including the first region, which is the invariant foreground region in the input image, and the second region, which is the boundary region between the foreground and background in the input image.

An alpha map may be understood as a map generated based on the probability that a certain area of an image is included in the foreground. The alpha map may be understood as a probability or transparency in which a background area is visualized by being overlaid with a foreground area when a final result is generated by synthesizing the foreground area and the background area that are separated from each other.

When an image is segmented into a foreground area and a background area, a technique for synthesizing the foreground area with another background area to create a new image is called image matting. In image matting, an alpha map indicating whether each pixel of an image is included in a foreground area, which is a region of interest or a background area, which is a region of non-interest, may be estimated using a weight. In image matting, a new image may be generated by synthesizing the foreground area, which is a region of interest, with another background area using the estimated alpha map.

As a means for identifying a foreground area in an image, a method of separating a region of interest from an image using an additional image, e.g., a blue screen, which includes background information obtained in a predetermined chroma-key environment or the like without simply using the image may be additionally used, but for the configuration of the present disclosure, only an input image may be analyzed or a technique for identifying an extended foreground area based on a user input may be used. In this process, some of the related art may be applied but a description of the details thereof may obscure the spirit of the present disclosure and thus is omitted herein, and in this case, there will be no problems with the understanding and implementation of the spirit and configuration of the present disclosure by those of ordinary skill in the art.

The present disclosure is intended to express a three-dimensional (3D) effect and details of a moving viewpoint motion picture, which is a final result, and to this end, a foreground mesh/texture map model may be generated by applying a foreground alpha map (or texture thereof) to a 3D mesh model.

In this case, the foreground mesh/texture map model may include information about a relationship between texture data generated based on the foreground alpha map and 3D meshes. In this case, the information about the relationship may be in the form of a table. The 3D foreground mesh model may include a mesh model for a first region that is an invariant foreground region and a second region that is a boundary region between the foreground and background.

To this end, according to the present disclosure, the 3D foreground mesh model may be generated by applying depth information for generating a 3D mesh model to an extended foreground area including the first region and the second region.

In addition, to this end, according to the present disclosure, a trimap with the extended foreground area including the first region and the second region may be generated. According to the present disclosure, by applying depth information and using a trimap including an extended foreground area during the generation of a 3D mesh model, foreground texture for the 3D mesh model can be easily applied and the amount of calculation and a memory usage can be reduced.

A moving viewpoint motion picture, which is a final result obtained in this process, is generated while the foreground texture is applied to the 3D mesh model, thus effectively expresses a 3D effect and detailed texture information.

Meanwhile, a depth value of an image may be obtained using a stereo camera, an active sensor that provides additional depth information by a time-of-flight (TOF) sensor, or the like. Alternatively, a depth value of an image may be obtained by providing guide information for a depth value according to a user input.

The above methods of additionally obtaining a depth value of an image may be techniques known prior to the filing date of the present application, and in this case, a detailed description thereof may obscure the spirit of the present disclosure and thus is omitted here.

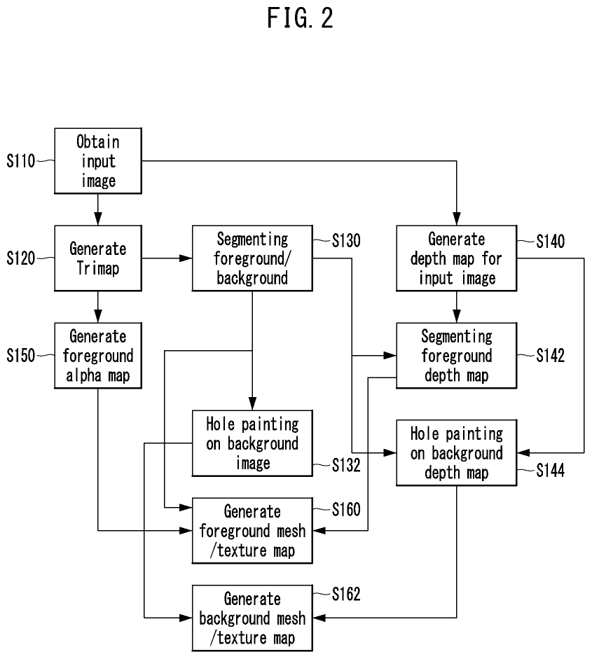

FIG. 2 is a detailed flowchart of some operations included in a method of generating a moving viewpoint motion picture according to an embodiment of the present disclosure.

A description of parts of FIG. 2 that is the same as that of FIG. 1 is omitted here.

The method of generating a moving viewpoint motion picture according to the embodiment of the present disclosure may further include generating a foreground alpha map (S150).

The method of generating a moving viewpoint motion picture according to the embodiment of the present disclosure may further include generating a depth map for the input image (S140). In this case, in the generating of the foreground mesh/texture map model (S160), a result of generating/segmenting a foreground depth map (S142) may be used, as foreground depth information, using the depth map and a trimap that includes an extended foreground area including a first region, which is an invariant foreground region of the input image, and a second region, which is a boundary region between the foreground and background of the input image. According to various embodiments of the present disclosure, the generating of the foreground mesh/texture map model (S160) may partially or entirely include the generating/segmenting of the foreground depth map (S142).

The method of generating a moving viewpoint motion picture according to the embodiment of the present disclosure may further include segmenting the input image into a foreground image and a background image (S130). In this case, the segmenting of the input image into the foreground image and the background image (S130) may include generating a mask for a third region.

The segmenting of the input image into the foreground image and the background image (S130) may include generating a mask for an extended foreground area including a first region and a second region. In this case, in the segmenting of the input image into the foreground image and the background image (S130), the input image may be segmented into the foreground image and the background image using the trimap with the extended foreground area that includes the first region and the second region.

The method of generating a moving viewpoint motion picture according to the embodiment of the present disclosure may further include performing hole painting on the background image including a third region, which is an invariant background region, of the input image (S132), and generating a background mesh/texture map model using a result of hole painting on the background image (S162).

Hole painting may be a technique of filling holes, which are blank regions, of the background image including the third region after the removal of the first and second regions, so that a connection part of the moving viewpoint motion picture may be processed seamlessly and naturally when the background image and the foreground mesh/texture map model are combined with each other. Known technologies such as in-painting may be used as an example of hole painting, but it will be obvious to those of ordinary skill in the art that the scope of the present disclosure is not limited thereby.

The method of generating a moving viewpoint motion picture according to the embodiment of the present disclosure may further include generating a depth map for the input image (S140), and generating initialized background depth information as a background depth map by applying the depth map to the third region (background image) which is the invariant background region of the input image. The method of generating a moving viewpoint motion picture according to the embodiment of the present disclosure may further include performing hole painting on the background depth map (S144). According to various embodiments of the present disclosure, the performing of hole painting on the background depth map (S144) may include a part or all of the generating of the initialized background depth information or the background depth map.

In this case, the generating of the background mesh/texture map model (S162) may include generating a background mesh/texture map model using a result of hole painting on the background depth information (or the background depth map).

In this case, the generating of the background mesh/texture map model (S162) may include generating a background mesh/texture map model using a result of hole painting on the background image and a result of hole painting on the background depth information.

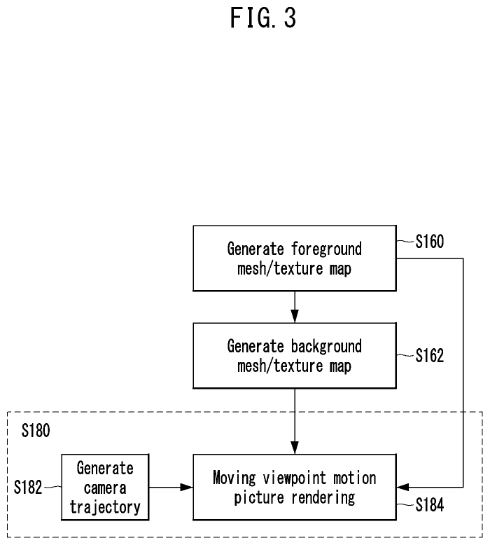

FIG. 3 is a detailed flowchart of some operations included in a method of generating a moving viewpoint motion picture according to an embodiment of the present disclosure.

The method of generating a moving viewpoint motion picture according to the embodiment of the present disclosure may further include generating a camera trajectory by assuming a movement of a virtual camera (S182). In this case, the generating of the moving viewpoint motion picture (S180) may include generating a moving viewpoint motion picture using a foreground mesh/texture map model and a background mesh/texture map model at a moving viewpoint generated based on the camera trajectory.

The generating of the moving viewpoint motion picture (S180) may include generating a camera trajectory (S182) and rendering the moving viewpoint motion picture using the camera trajectory (S184).

In the rendering of the moving viewpoint motion picture (S184), the moving viewpoint motion picture may be rendered using the foreground mesh/texture map model generated in the generating of the foreground mesh/texture map model (S160), the background mesh/texture map model generated in the generation of the background mesh/texture map model (S162), and information about the camera trajectory.

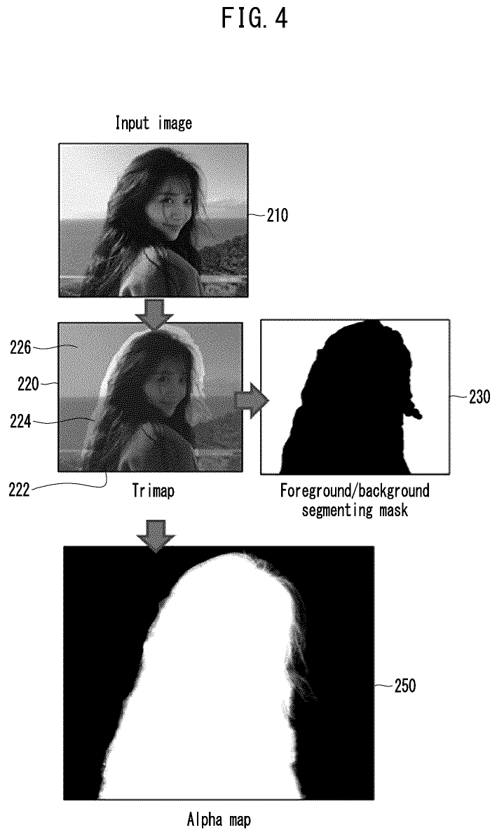

FIG. 4 is a conceptual diagram illustrating an intermediate result generated in a process of generating a moving viewpoint motion picture according to an embodiment of the present disclosure.

An input image 210 may be a color image including RGB values. Here, the color image is not limited to RGB colors and may be expressed in various forms.

A trimap 220 may include a first region 222 that is an invariant foreground region, a second region 224 that is a boundary region between the foreground and background, and a third region 226 that is an invariant background region. A foreground/background segmenting mask 230 may be a mask for differentiating between an extended foreground area including the first region 222 and the second region 224 and the third region 226.

A foreground alpha map 250 may be determined based on a probability that each region of the input image 210 is included in a foreground area. In this case, details of hair may be included and expressed in the foreground alpha map 250.

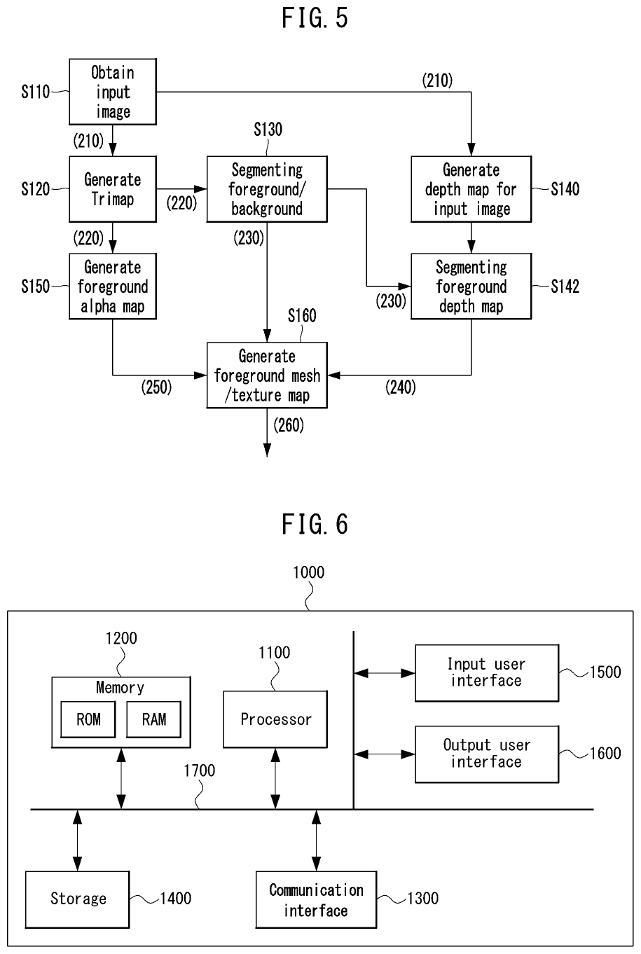

FIG. 5 is a flowchart of some operations included in a method of generating a moving viewpoint motion picture and an intermediate result according to an embodiment of the present disclosure.

Referring to FIGS. 1 to 5, an input image 210 obtained in the obtaining of the input image (S110) may be transferred to the generating of the trimap (S120).

The generating of the trimap (S120) may include receiving a user input for the input image 210; and generating the trimap 220 based on the user input.

For example, a user may designate a foreground outline candidate region including an outline of the foreground using a graphical user interface (GUI) for the input image 210. The foreground outline candidate region designated by the user may be considered a user input.

Based on a result of analyzing the foreground outline candidate region, the first region 222 of the foreground outline candidate region may be determined as an invariant foreground region and the second region 224 of the foreground outline candidate region excluding the first region 222 may be determined as a boundary region between the foreground and background. The third region 226, which is a region outside the foreground outline candidate region, may be determined as an invariant background region.

According to various embodiments of the present disclosure, the generating of the trimap (S120) may include analyzing the input image 210, and automatically generating the trimap 220 based on a result of analyzing the input image 210. In this case, the input image 210 may be analyzed and segmented into the first region 222, the second region 224, and the third region 226 without determining the foreground outline candidate region based on a user input.

According to another embodiment of the present disclosure, the user input may be verified or modified based on an automatic image analysis result or the automatic image analysis result may be verified or modified according to the user input.

In this case, it will be obvious to those of ordinary skill in the art that the automatic image analysis result may be obtained by performing a known technique, such as object detection or object/region segmentation, on the image, and a rule-based or artificial neural network technology is applicable.

The generating of the foreground alpha map (S150) may include generating the foreground alpha map 250 indicating a probability that each pixel of the input image 210 is included in the foreground area based on the input image 210 and the trimap 220. The foreground alpha map 250 may be generated by a technique known prior to the filing date of the present application.

In the segmenting of the input image 210 into the foreground image and the background image, the invariant foreground region and the foreground outline candidate region that are obtained in the generating of the trimap (S120) may be considered together as an extended foreground area. The invariant background region may be considered as a background area, and the foreground/background segmenting mask 230 for differentiating between the foreground area and the background area may be generated.

In the generating of the depth map for the input image (S140), an input image depth map representing a depth value estimated for each pixel of the input image 210 may be generated. A depth map may be generated from the input image 210 by a known technique. The generating of the depth map for the input image (S140) may be performed in parallel or independently with the generating of the trimap (S120) and the segmenting of the input image 210 into the foreground image and the background image (S130).

In the generating of the foreground depth map (S142), the foreground depth map 240 may be generated using the depth map and the foreground/background segmenting mask 230 as inputs. The foreground depth map 240 may include a foreground area expressed by allocating depth values thereto. In this case, the foreground area may be an extended foreground area. A background area of the foreground depth map 240 may not be considered in subsequent operations, and information indicating this may be expressed. For example, the background area of the foreground depth map 240 may be filled with a NULL value.

Referring to the embodiments of FIGS. 1 to 5, according to the present disclosure, a moving viewpoint motion picture obtained when photographing is performed while moving a camera can be obtained by inputting only one photo image.

In the performing of hole painting on the background image (S132), the input image 210 and the foreground/background segmenting mask 230 may be used as inputs. In this case, a process of performing hole painting may be a known technique.

In the performing of hole painting on the background depth map (S144), the depth map and the foreground/background segmenting mask 230 may be used as inputs. In the performing of hole painting on the background depth map (S144), first, an initial value of the background depth map (or initialized background depth information) may be first generated. The initial value of the background depth map may represent a depth value of only each pixel of the background area, and the foreground area may be filled with values (e.g., a NULL value) that will not be considered in subsequent operations. In the performing of hole painting on the background depth map (S144), hole painting may be performed on the initial value of the background depth map. In this case, hole painting may be performed by a known technique.

In the generating of the foreground mesh/texture map model (S160), the foreground mesh/texture map model 260 may be generated using the foreground/background segmenting mask 230, the foreground depth map 240, and the foreground alpha map 250 obtained from the input image 210.

The foreground mesh/texture map model 260 may be a 2.5 D mesh model generated using depth information of the foreground depth map 240 for the extended foreground area. The foreground mesh/texture map model 260 may be in the form of a texture map having color values, which is generated by adding an additional channel (alpha channel) in addition to RGB values while reflecting the alpha map 250 for the extended foreground area.

In the generating of the background mesh/texture map model (S162), the background mesh/texture map model may be generated using the input image 210, the foreground/background segmenting mask 230 obtained from the input image 210, and the background depth map.

The background mesh/texture map model may be a 2.5 D mesh model generated using the depth information of the background depth map for the background area. The background mesh/texture map model may be in the form of a texture map having color values generated by reflecting the RGB values of the input image 210 for the background area.

In the generating of the moving viewpoint motion picture (S180), the moving viewpoint motion picture may be generated using the foreground mesh/texture map model 260 and the background mesh/texture map model.

In the generating of the camera trajectory (S182), a moving trajectory of a virtual camera may be generated according to a user input or a preset rule. In this case, the user input may include at least one of a directional input using a user interface such as a keyboard/mouse, a text input using a user interface such as a keyboard/keypad, or a user input corresponding to a GUI. The foreground mesh/texture map model 260 and the background mesh/texture map model that have been generated above may be rendered according to a moving trajectory of the virtual camera.

In the rendering of the moving viewpoint motion picture (S184), a moving viewpoint motion picture, which is a final result, may be generated using, as inputs, the moving trajectory of the virtual camera, the foreground mesh/texture map model 260, and the background mesh/texture map model.

A moved viewpoint and a direction in which the background mesh/texture map model is to be projected may be determined by the moving trajectory of the virtual camera. A background image of the moving viewpoint motion picture may be determined based on a direction in which the background mesh/texture map model is projected.

The foreground mesh/texture map model 260 may overlap the front of the background mesh/texture map model so that the moving viewpoint motion picture may be rendered. In this case, the transparency of each detailed region of the extended foreground area may be determined based on an alpha channel value of the alpha map 250 included in the texture map of the foreground mesh/texture map model 260. The detailed regions may be regions included in one mesh and having different alpha channel values according to a texture map corresponding to each mesh of the 2.5D mesh model.

Referring to the embodiments of FIGS. 1 to 5, the present disclosure provides a technique for expressing a 3D effect and details of a foreground object even when only one photo image is input.

Key techniques of the present disclosure, such as the technique for estimating a depth map from a 2D image, the technique for segmenting a 2D image into a foreground object and a background, and the technique for synthesizing a foreground object with various backgrounds to obtain a result image different from an original image, are well-known techniques, and the present disclosure is not intended to claim rights thereto. The present disclosure is directed to providing a moving viewpoint motion picture synthesis technique for effectively expressing details of a foreground object, which are difficult to express.

According to the present disclosure, when an input image is, for example, one photo image, it is possible to effectively express the details of a boundary of an object in the input image and a 3D effect added for the combination of the object and background when a background image is changed while moving a viewpoint of a virtual camera. The result image according to the present disclosure is a moving viewpoint motion picture substantially the same as that captured while moving a camera forward, and details and a 3D effect of even a part, e.g., hair, that is difficult to express can be expressed by effectively segmenting the part into a foreground and background. In a 3D mesh model of the present disclosure, information about the rear of a foreground object may not be expressed and thus may be referred to as a 2.5D mesh model.

To obtain such a result image by synthesis, according to the present disclosure, a depth map of an input image may be estimated, a 3D mesh model may be generated, and an alpha map may be applied to the 3D mesh model to express texture information.

In this case, in order to effectively combine the 3D mesh model with the alpha map, the 3D mesh model may be generated for an extended foreground area. A mapping table showing a relationship between each mesh of the 3D mesh model of the extended foreground area and texture information of the alpha map may be included as part of a mesh/texture map model of the present disclosure.

In the related art to be compared with the configuration of the present disclosure, it is very difficult to express a sense of separation from the background, a 3D effect, and details of a detailed region even at the level of hair when a moving viewpoint motion picture is generated after a photo-based 3D model is obtained. This is because in the related art, it is very difficult to generate a 3D mesh model for detailed regions such as hair and body hair.

According to the present disclosure, details of texture, a 3D effect, and a sense of separation from the background can be effectively expressed while reducing a memory usage and the amount of calculation, compared to the method of the related art in which a mesh model is separately generated for detailed regions, such as hair and body hair, for which texture should be minutely expressed. According to the present disclosure, a mesh model is generated for an extended foreground area, and an alpha channel/alpha map for determining the transparency of a texture map is applied to the mesh model, so that in regions in which details such as hair and body hair should be elaborately expressed, a sense of separation from the background and an indirect 3D effect may be expressed.

That is, the present disclosure is characterized in that when a mesh model is generated for the generation of a foreground mesh/texture map model 260, the mesh model is generated to include an extended foreground area rather than a fixed foreground area.

The present disclosure is also characterized in that a texture map of the foreground mesh/texture map model 260 is generated by adding an alpha channel/alpha map for determining transparency in addition to RGB values of the input image 210, which is an original image.

The present disclosure is also characterized in that transparency is determined by an alpha channel value included in the texture map of the foreground mesh/texture map model 260 to render a moving viewpoint motion picture, which is a final result, while the foreground mesh/texture map model 260 is superimposed in front of the background mesh/texture map model.

In this case, similar to the foreground mesh/texture map model 260 for an extended foreground area, a background area of the moving viewpoint motion picture is generated by rendering the background mesh/texture map model, and thus, a 3D effect can be added to a background image that is variable according to a moving trajectory of a virtual camera and a 3D effect of the moving viewpoint motion picture, which is a final result, can be improved.

Examples of an application applicable to the configuration of the present disclosure include an application for performing rendering based on a moving trajectory of a virtual camera that three-dimensionally visualizes a picture of a person, an application for converting a picture that captures an individual's travel or daily moments into a video that three-dimensionally visualizes the picture, and the like. Results according to the present disclosure may be shared at online/offline exhibitions, on websites, or on social network services (SNS), and may be used as means for promoting or guiding events, content, and travel sites.

FIG. 6 is a conceptual diagram illustrating an example of a generalized apparatus or computing system for generating a moving viewpoint motion picture, which is capable of performing at least some of the methods of FIGS. 1 to 5.

At least some operations and/or procedures of the method of generating a moving viewpoint video according to an embodiment of the present disclosure may be performed by a computing system 1000 of FIG. 6.

Referring to FIG. 6, the computing system 1000 according to an embodiment of the present disclosure may include a processor 1100, a memory 1200, a communication interface 1300, a storage device 1400, an input interface 1500, an output interface 1600 and a bus 1700.

The computing system 1000 according to an embodiment of the present disclosure may include at least one processor 1100, and the memory 1200 storing instructions to instruct the at least one processor 1100 to perform at least one operation. At least some operations of the method according to an embodiment of the present disclosure may be performed by loading the instructions from the memory 1200 and executing the instructions by the at least one processor 1100.

The processor 1100 may be understood to mean a central processing unit (CPU), a graphics processing unit (GPU), or a dedicated processor configured to perform methods according to embodiments of the present disclosure.

Each of the memory 1200 and the storage device 1400 may include at least one of a volatile storage medium or a nonvolatile storage medium. For example, the memory 1200 may include at least one of a read-only memory (ROM) or a random access memory (RAM).

The computing system 1000 may include the communication interface 1300 that performs communication through a wireless network.

The computing system 1000 may further include the storage device 1400, the input interface 1500, the output interface 1600, and the like.

The components of the computing system 1000 may be connected to one another via the bus 1700 to communicate with one another.

Examples of the computing system 1000 of the present disclosure may include a desktop computer, a laptop computer, a notebook, a smart phone, a tablet PC, a mobile phone, a smart watch, smart glasses, an e-book reader, a portable multimedia player (PMP), a portable game console, a navigation device, a digital camera, a digital multimedia broadcasting (DMB) player, a digital audio recorder, a digital audio player, a digital video recorder, a digital video player, a personal digital assistant (PDA), and the like, which are capable of establishing communication.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An apparatus for generating a moving viewpoint motion picture, comprising:
a memory; and
a processor configured to execute at least one instruction stored in the memory,
wherein, by executing the at least one instruction, the processor is configured to:
obtain an input image;
generate a trimap from the input image;
generate a foreground mesh/texture map model based on a foreground alpha map obtained based on the trimap and foreground depth information obtained based on the trimap; and
generate a moving viewpoint motion picture based on the foreground mesh/texture map model.

2. The apparatus of claim 1, wherein the processor is further configured to:
generate the trimap to include an extended foreground area including a first region and a second region, the first region being an invariant foreground region of the input image and the second region being a boundary region between a foreground and a background of the input image; and
generate the foreground mesh/texture map model including a three-dimensional (3D) mesh model for the extended foreground area.

3. The apparatus of claim 2, wherein the processor is further configured to apply the foreground alpha map to a texture map for the second region.

4. The apparatus of claim 1, wherein the processor is further configured to generate the foreground mesh/texture map model including information of a relation between texture data generated based on the foreground alpha map and a 3D mesh for an extended foreground area including a first region being an invariant foreground region of the input image and a second region being a boundary region between a foreground and a background of the input image.

5. The apparatus of claim 1, wherein the processor is further configured to:
generate a depth map for the input image; and
generate the foreground depth information using the trimap and the depth map, wherein the trimap includes an extended foreground area including a first region being an invariant foreground region of the input image and a second region being a boundary region between a foreground and a background of the input image.

6. The apparatus of claim 1, wherein the processor is further configured to:
perform hole painting on a background image including a third region being an invariant background region of the input image; and
generate a background mesh/texture map model using a result of hole painting on the background image.

7. The apparatus of claim 6, wherein the processor is further configured to:
generate a depth map for the input image;
generate initialized background depth information by applying the depth map to the third region which is the invariant background region of the input image;
perform hole painting on the background depth information; and
generate the background mesh/texture map model using a result of hole painting on the background depth information and the result of hole painting on the background image.

8. The apparatus of claim 1, wherein the processor is further configured to:
generate a camera trajectory by assuming a movement of a virtual camera; and
generate the moving viewpoint motion picture using the foreground mesh/texture map model and a background mesh/texture map model at a moving viewpoint generated based on the camera trajectory.

9. The apparatus of claim 1, wherein the processor is further configured to generate the trimap based on a user input for the input image.

10. The apparatus of claim 1, wherein the processor is further configured to automatically generate the trimap based on the input image.

11. A method of generating a moving viewpoint motion picture, which is performed by a processor that executes at least one instruction stored in a memory, the method comprising:
obtaining an input image;
generating a trimap from the input image;
generating a depth map using the input image;
generating a foreground mesh/texture map model based on a foreground alpha map obtained based on the trimap and foreground depth information obtained based on the trimap and the depth map; and
generating a moving viewpoint motion picture based on the foreground mesh/texture map model.

12. The method of claim 11, wherein the generating of the trimap comprises generating the trimap to include an extended foreground area including a first region and a second region, the first region being an invariant foreground region of the input image and the second region being a boundary region between a foreground and a background of the input image, and
the generating of the foreground mesh/texture map model comprises generating the foreground mesh/texture map model including a three-dimensional (3D) mesh model for the extended foreground area.

13. The method of claim 12, wherein the generating of the foreground mesh/texture map model comprises generating the foreground mesh/texture map model by applying the foreground alpha map to a three-dimensional (3D) mesh model for the second region.

14. The method of claim 11, wherein the generating of the foreground mesh/texture map model comprises generating the foreground mesh/texture map model including information of a relation between texture data generated based on the foreground alpha map and a 3D mesh for an extended foreground area including a first region being an invariant foreground region of the input image and a second region being a boundary region between a foreground and a background of the input image.

15. The method of claim 11, wherein the generating of the foreground mesh/texture map model comprises generating the foreground depth information using the trimap and the depth map, wherein the trimap includes an extended foreground area including a first region being an invariant foreground region of the input image and a second region being a boundary region between a foreground and a background of the input image.

16. The method of claim 11, further comprising:
hole painting on a background image including a third region being an invariant background region of the input image; and
generating a background mesh/texture map model using a result of the hole painting on the background image.

17. The method of claim 16, further comprising:
generating a depth map for the input image;
generating initialized background depth information by applying the depth map to the third region which is the invariant background region of the input image; and
hole painting on the background depth information, and
wherein the generating of the background mesh/texture map model comprises generating the background mesh/texture map model using a result of the hole painting on the background depth information.

18. The method of claim 11, further comprising:
generating a camera trajectory by assuming a movement of a virtual camera, and
wherein the generating of the moving viewpoint motion picture comprises generating the moving viewpoint motion picture using the foreground mesh/texture map model and a background mesh/texture map model at a moving viewpoint generated based on the camera trajectory.

19. The method of claim 11, wherein the generating of the trimap comprises:
receiving a user input for the input image; and
generating the trimap based on the user input.

20. The method of claim 11, wherein the generating of the trimap comprises:
analyzing the input image; and
automatically generating the trimap based on a result of the analyzing the input image.
